(19) United States
(12) Patent Application Publication
(10) Pub. No.: US 2023/0028635 A1
(43) Pub. Date: Jan. 26, 2023

(54) TECHNIQUES FOR MANAGING CONTAINER-BASED SOFTWARE SERVICES

(71) Applicant: VIANAI SYSTEMS, INC., Palo Alto, CA (US)

(72) Inventors: Kevin Frederick DUNNELL, Waltham, MA (US); Thomas J. MARTIN, JR., Oviedo, FL (US); Vishal Inder SIKKA, Los Altos Hills, CA (US)

(21) Appl. No.: 17/867,591

(22) Filed: Jul. 18, 2022

Related U.S. Application Data
(60) Provisional application No. 63/223,412, filed on Jul. 19, 2021.

(51) Int. Cl. G06F 9/54; G06F 9/50

(52) U.S. Cl. CPC G06F 9/545; G06F 9/546; G06F 9/505

(57) ABSTRACT

One embodiment of the present invention sets forth a technique for executing one or more services in a technology stack. The technique includes deploying a first set of containers within an environment, wherein each container included in the first set of containers includes a first service that implements a first interface and a first shim that implements a second interface. The technique also includes transmitting a first request associated with the second interface to a first container included in the first set of containers, wherein the first request is processed by an instance of the first shim and an instance of the first service executing within the first container.

### CROSS-REFERENCE TO RELATED APPLICATIONS

This application claims benefit of the United States Provisional Patent Application titled “MICRO-SERVICE-AGNOSTIC ARTIFICIAL INTELLIGENCE COMPUTING PLATFORM,” filed Jul. 19, 2021, and having Ser. No. 63/223,412. The subject matter of this related application is hereby incorporated herein by reference.

### BACKGROUND

### Field of the Various Embodiments

Embodiments of the present disclosure relate generally to computer science and software architecture and, more specifically, to techniques for managing container-based software services.

### Description of the Related Art

Software-based workflows are typically implemented in the form of technology “stacks.” Each technology stack is composed of discrete services that provide different subsets of functionality associated with a corresponding software-based workflow. For example, a technology stack for a machine learning workflow could include services that are used to store machine learning models and/or features, select or engineer features, create or train machine learning models, deploy machine learning models in various environments, monitor the execution of the machine learning models in the various environments, and/or perform other tasks related to machine learning. A given technology stack may change over time as services are added, upgraded, replaced, or deprecated within a corresponding software-based workflow to reflect changes to the underlying technology. For example, a first service within a technology stack could be replaced with a second service when the first service is no longer able to scale to meet the needs of the user of the technology stack, when the second service improves the functionality imparted by the first service, and/or when the first service is no longer supported.

One drawback to using conventional technology stack architectures is that the services within a given technology stack are typically “hardcoded” to interoperate with one another. Accordingly, when a service is added, modified, or replaced within a technology stack, additional components have to be added to the technology stack to adapt the other services within the technology stack to the interfaces and features implemented by the added or modified service. For example, adding a new service to a technology stack could require a separate “driver” to be created and installed within the technology stack, where the driver allows the other services in the technology stack to make calls to the interface implemented by the new service. Similarly, modifying the interface implemented by an existing service within a technology stack could require code-based adaptations that allow the other services within the technology stack to interact with the modified service.

As the foregoing illustrates, what is needed in the art are more effective techniques for modifying the services that are implemented in technology stacks.

### SUMMARY

One embodiment of the present invention sets forth a technique for executing one or more services in a technology stack. The technique includes deploying a first set of containers within an environment, wherein each container included in the first set of containers includes a first service that implements a first interface and a first shim that implements a second interface. The technique also includes transmitting a first request associated with the second interface to a first container included in the first set of containers, wherein the first request is processed by an instance of the first shim and an instance of the first service executing within the first container.

One technical advantage of the disclosed techniques relative to the prior art is that, with the disclosed techniques, the same interface can be used to access multiple services that provide similar functionality within a given technology stack. Accordingly, the disclosed techniques enable a service to be added, updated, upgraded, or replaced within the technology stack without having to create and install a custom “driver” to accommodate the modified or added service or change the interfaces of the other implemented in the technology stack, as is normally required with prior art approaches. Another technical advantage of the disclosed techniques is that, because a service and a corresponding shim are packaged together within the same container, the service and shim are isolated from other components executing within the same environment. This isolation allows the service and shim to be deployed, moved, and removed as a single self-contained unit, which is more efficient relative to prior art approaches where services and components are packaged, deployed, and managed separately. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments.

FIG. 2 is a more detailed illustration of the AI design application of FIG. 1, according to various embodiments.

FIG. 3 is a more detailed illustration of the network generator of FIG. 2, according to various embodiments.

FIG. 4 is a more detailed illustration of the compiler engine and the synthesis engine of FIG. 3, according to various embodiments.

FIG. 5 illustrates an implementation of the system of FIG. 1 that includes container-based abstractions of services, according to various embodiments.

FIG. 6 sets forth a flow diagram of method steps for implementing one or more services in a technology stack, according to various embodiments.

FIG. 7 sets forth a flow diagram of method steps for processing a request associated with a service implemented in a technology stack, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

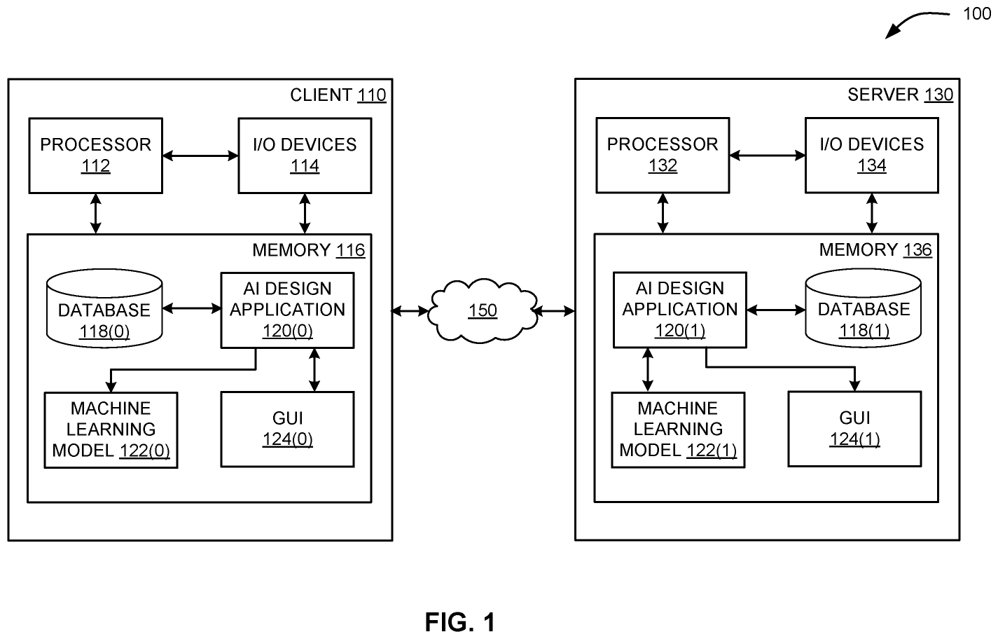

FIG. 1 illustrates a system 100 configured to implement one or more aspects of the various embodiments. As shown, system 100 includes a client 110 and a server 130 coupled together via network 150. Client 110 or server 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others. Client 110 and server 130 are configured to communicate via network 150.

As further shown, client 110 includes processor 112, input/output (I/O) devices 114, and memory 116, coupled together. Processor 112 includes any technically feasible set of hardware units configured to process data and execute software applications. For example, processor 112 could include one or more central processing units (CPUs), one or more graphics processing units (CPUs), and/or one or more parallel processing units (PPUs). I/O devices 114 include any technically feasible set of devices configured to perform input and/or output operations, including, for example, a display device, a keyboard, and a touchscreen, among others.

Memory 116 includes any technically feasible storage media configured to store data and software applications, such as, for example, a hard disk, a random-access memory (RAM) module, and a read-only memory (ROM). Memory 116 includes a database 118(0), an artificial intelligence (AI) design application 120(0), a machine learning model 122(0), and a graphical user interface (GUI) 124(0). Database 118(0) is a file system and/or data storage application that stores various types of data. AI design application 120(0) is a software application that, when executed by processor 112, interoperates with a corresponding software application executing on server 130 to generate, analyze, evaluate, and describe one or more machine learning models. Machine learning model 122(0) includes one or more artificial neural networks, decision trees, random forests, gradient boosted trees, regression models, support vector machines, Bayesian networks, hierarchical models, ensemble models, and/or other types of machine learning models configured to perform general-purpose or specialized artificial intelligence-oriented operations. GUI 124(0) allows a user to interface with AI design application 120(0).

Server 130 includes processor 132, I/O devices 134, and memory 136, coupled together. Processor 132 includes any technically feasible set of hardware units configured to process data and execute software applications, such as one or more CPUs, one or more GPUs, and/or one or more PPUs. I/O devices 134 include any technically feasible set of devices configured to perform input and/or output operations, such as a display device, a keyboard, or a touchscreen, among others.

Memory 136 includes any technically feasible storage media configured to store data and software applications, such as, for example, a hard disk, a RAM module, and a ROM. Memory 136 includes database 118(1), AI design application 120(1), Machine learning model 122(1), and GUI 124(1). Database 118(1) is a file system and/or data storage application that stores various types of data, similar to database 118(1). For example, databases 118(0)-(1) could include (but are not limited to) feature repositories that store features used in machine learning, model repositories that store machine learning models 112(0)-(1), and/or data stores for other types of data related to machine learning. AI design application 120(1) is a software application that, when executed by processor 132, interoperates with AI design application 120(0) to generate, analyze, evaluate, and describe one or more machine learning models. Machine learning model 122(1) includes one or more artificial neural networks, decision trees, random forests, gradient boosted trees, regression models, support vector machines, Bayesian networks, hierarchical models, ensemble models, and/or other types of machine learning models configured to perform general-purpose or specialized artificial intelligence-oriented operations. GUI 124(1) allows a user to interface with AI design application 120(1).

As a general matter, database 118(0) and 118(1) represent separate portions of a distributed storage entity. Thus, for simplicity, databases 118(0) and 118(1) are collectively referred to herein as database 118. Similarly, AI design applications 120(0) and 120(1) represent separate portions of a distributed software entity that is configured to perform any and all of the inventive operations described herein. As such, AI design applications 120(0) and 120(1) are collectively referred to hereinafter as AI design application 120. Machine learning models 122(0) and 122(1) likewise represent a distributed machine learning model that includes one or more artificial neural networks, decision trees, random forests, gradient boosted trees, regression models, support vector machines, Bayesian networks, hierarchical models, ensemble models, and/or other types of machine learning models. Accordingly, machine learning models 122(0) and 122(1) are collectively referred to herein as machine learning model 122. GUIs 124(0) and 124(1) similarly represent distributed portions of one or more GUIs. GUIs 124(0) and 124(1) are collectively referred to herein as GUI 124.

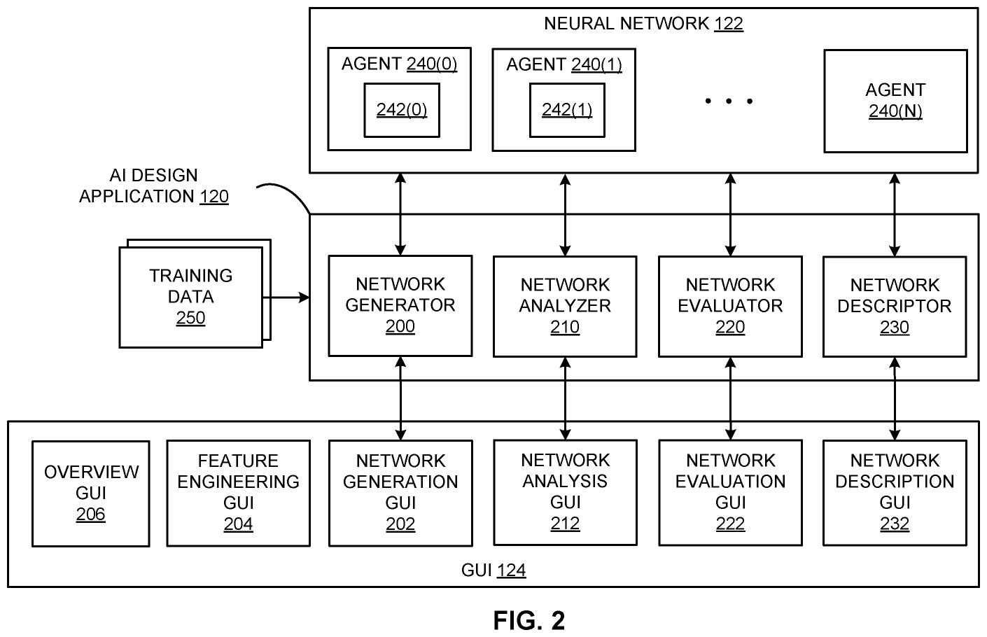

In operation, AI design application 120 generates machine learning model 122 based on user input that is received via GUI 124. GUI 124 exposes design and analysis tools that allow the user to create and edit machine learning model 122, explore the functionality of machine learning model 122, evaluate machine learning model 122 relative to training data, and generate various data describing and/or constraining the performance and/or operation of machine learning model 122, among other operations. Various modules within AI design application 120 that perform the above operations are described in greater detail below in conjunction with FIG. 2.

FIG. 2 is a more detailed illustration of AI design application 120 of FIG. 1, according to various embodiments. As shown, AI design application 120 includes network generator 200, network analyzer 210, network evaluator 220, and a network descriptor 230. As also shown, machine learning model 122 includes one or more agents 240, and GUI 124 includes overview GUI 206, feature engineering GUI 204, network generation GUI 202, network analysis GUI 212, network evaluation GUI 222, and network description GUI 232.

In operation, network generator 200 renders network generation GUI 202 to provide the user with tools for designing and connecting agents 240 within machine learning model 122. A given agent 240 may include a neural network 242 that performs various AI-oriented tasks. A given agent 240 may also include other types of functional elements that perform generic tasks. Network generator 200 trains neural networks 242 included in specific agents 240 based on training data 250. Training data 250 can include any technically feasible type of data for training neural networks. For example, training data 250 could include the Modified National Institute of Standards and Technology (MNIST) digits training set.

When training is complete, network analyzer 210 renders network analysis GUI 212 to provide the user with tools for analyzing and understanding how a neural network within a given agent 240 operates. In particular, network analyzer 210 causes network analysis GUI 212 to display various connections and weights within a given neural network 242 and to simulate the response of the given neural network 242 to various inputs, among other operations.

In addition, network evaluator 220 renders network evaluation GUI 222 to provide the user with tools for evaluating a given neural network 242 relative to training data 250. More specifically, network evaluator 220 receives user input via network evaluation GUI 222 indicating a particular portion of training data 250. Network evaluator 220 then simulates how the given neural network 242 responds to that portion of training data 250. Network evaluator 220 can also cause network evaluation GUI 222 to filter specific portions of training data 250 that cause the given neural network 242 to generate certain types of outputs.

In conjunction with the above, network descriptor 230 analyzes a given neural network 242 associated with an agent 240 and generates a natural language expression that describes the performance of the neural network 242 to the user. Network descriptor 230 can also provide various “common sense” facts to the user related to how the neural network 242 interprets training data 250. Network descriptor 230 outputs this data to the user via network description GUI 232. In addition, network descriptor 230 can obtain rule-based expressions from the user via network description GUI 232 and then constrain network behavior based on these expressions. Further, network descriptor 230 can generate metrics that quantify various aspects of network performance and then display these metrics to the user via network description GUI 232.

As shown, GUI 124 additionally includes overview GUI 206 and feature engineering GUI 204, which may be rendered by AI design application 120 and/or another component of the system. Overview GUI 206 includes one or more user-interface elements for viewing, setting, and/or otherwise managing objectives associated with projects or experiments involving neural network 242 and/or other machine learning models 122. Feature engineering GUI 204 includes one or more user-interface elements for viewing, organizing, creating, and/or otherwise managing features inputted into neural network 242 and/or other machine learning models 122.

Referring generally to FIGS. 1-2, AI design application 120 advantageously provides the user with various tools for generating, analyzing, evaluating, and describing neural network behavior. The disclosed techniques differ from conventional approaches to generating neural networks, which generally obfuscate network training and subsequent operation from the user.

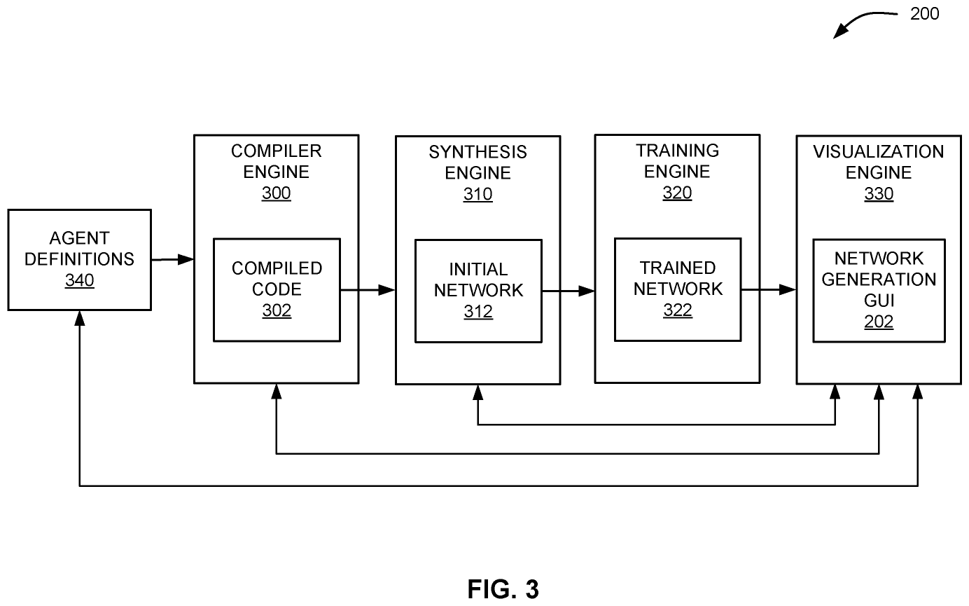

FIG. 3 is a more detailed illustration of the network generator of FIG. 1, according to various embodiments. As shown, network generator 200 includes compiler engine 300, synthesis engine 310, training engine 320, and visualization engine 330.

In operation, visualization engine 330 generates network generation GUI 202 and obtains agent definitions 340 from the user via network generation GUI 202. Compiler engine 300 compiles program code included in a given agent definition 340 to generate compiled code 302. Compiler engine 300 is configured to parse, compile, and/or interpret any technically feasible programming language, including C, C++, Python and associated frameworks, JavaScript and associated frameworks, and so forth. Synthesis engine 310 generates initial network 312 based on compiled code 302 and on or more parameters that influence how that code executes. Initial network 312 is untrained and may not perform one or more intended operations with a high degree of accuracy.

Training engine 320 trains initial network 312 based on training data 250 to generate trained network 322. Trained network 322 may perform the one or more intended operations with a higher degree of accuracy than initial network 312. Training engine 320 may perform any technically feasible type of training operation, including backpropagation, gradient descent, and so forth. Visualization engine 330 updates network generation GUI 202 in conjunction with the above operations to graphically depict the network architecture defined via agent definition 340 as well as to illustrate various performance attributes of trained network 322.

### Programming and Executing Neural Network Agents

As discussed above, in order to define and execute a neural network architecture, a developer typically uses cumbersome tools and libraries that are difficult to master and often obfuscate much of the details of the underlying network architecture. As a consequence, neural networks can be created only by a few set of developers who have expertise in the various tools and libraries. Further, because the underlying details of a network architecture are nested deep within the frameworks of the tools and libraries, a developer may not understand how the architecture functions or how to change or improve upon the architecture. To address these and other deficiencies in the neural network definition paradigm, a mathematics-based programming and execution framework for defining neural network architectures is discussed below.

In various embodiments, the source code for a neural network agent definition in a mathematics-based programming language is a pipeline of linked mathematical expressions. The source code is compiled into machine code without needing any intermediary libraries, where the machine code is representative of a trainable and executable neural network. In order for the neural network architecture to be defined in source code as a series of mathematical expressions, the mathematics-based programming language exposes several building blocks. These include a layer notation for specifying a layer of a neural network, a link notation for specifying a link between two or more layers of a neural network or two or more neural networks, a variable assignment notation for specifying a source of a variable (=), and various mathematical operation notations such as sum (+), division (/), summation (Σ), open and close parenthesis (( )), matrix definition, set membership (∈), etc.

Each layer of a neural network is defined in the mathematics-based programming language as one or more mathematical expressions using the building blocks discussed above. For example, a convolution layer may be defined using the following source code that includes a set of mathematical expressions:

$$CONVOLUTION : ( X ∈ \text{?} ) \to ( Y ∈ \text{?} ) \\ where \\ {y}_{i , j , k} = {( \text{?} \text{?} \text{?} \text{?} a + {b}_{k} )}^{+} \\ W ∈ \text{?} \\ b ∈ \text{?} \\ r , a , z ∈ Z \\ c = \text{?} ( i - 1 ) - z + 1 \\ d = \text{?} ( j - 1 ) - z + u \\ a = \{ \begin{matrix}\text{?} if 1 \leq c \leq m and 1 \leq d \leq m \\ 0 otherwise\end{matrix} \\ \text{?} \text{indicates text missing or illegible when filed}$$

In the above example, the first line of the source code indicates that the subsequent lines of the source code are related to a CONVOLUTION operation that has an input X and an output Y. The subsequent lines of the source code include a sequence of mathematical expressions that define the mathematical operations performed on the input X to generate the output Y. Each mathematical expression includes a right hand-side portion and a left-hand side portion. The right-hand side portion specifies a value that is determined when a mathematics operation specified by the left-hand portion is evaluated. For example, in the mathematical expression “c=s(l−1)−z+t” shown above, “c” is the right-handle portion and specifies that the variable c is assigned to the value generated when “s(i−1)−z+t” is evaluated.

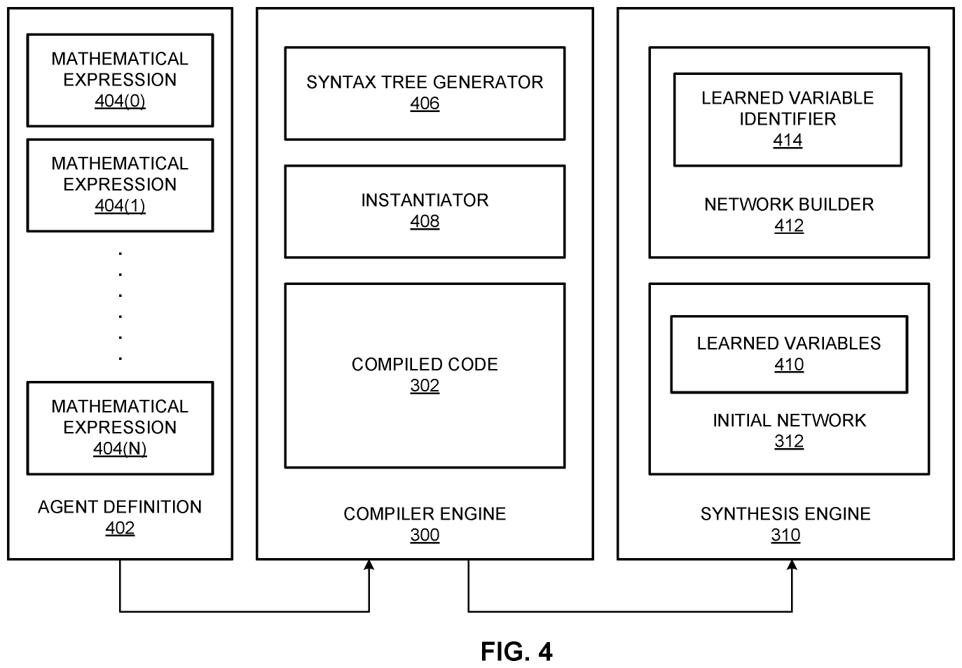

The values of variables included in the source code of a neural network agent are either assigned when the neural network is instantiated or are learned during training of the neural network. Unlike other neural network definition paradigms, a developer of a neural network agent defined using the mathematics-based programming language has control over which variables are to be learned during training (referred to herein as “learned variables”). Further, the variables that are to be learned during training can remain uninitialized (i.e., without being assigned a value or a source of a value) even when the neural network is instantiated. The techniques for handling these learned variables during the compilation and training of a neural network are discussed below in detail in conjunction with FIGS. 4-6.

FIG. 4 is a more detailed illustration of compiler engine 300 and synthesis engine 310 of FIG. 3, according to various embodiments. As shown, compiler engine 300 includes syntax tree generator 406, instantiator 408, and compiled code 302. Synthesis engine 310 includes network builder 412 and initial network 312, which includes learned variables 410.

The operation of compiler engine 300 and synthesis engine 310 are described in conjunction with a given agent definition 402. The source code of agent definition 402 includes multiple layer specifications, where each layer specification includes one or more mathematical expressions 404 (individually referred to as mathematical expression 404) defined using the mathematics-based programming language. As discussed above, each mathematical expression 404 includes a right-hand side portion that specifies a value that is determined when a mathematics operation specified by the left-hand portion is evaluated. Mathematical expressions 404 may be grouped, such that each group corresponds to a different layer of a neural network architecture. The source code of agent definition 402 specifies the links between different groups of mathematical expressions 404.

Compiler engine 300 compiles the source code of agent definition 402 into compiled code 302. To generate compiled code 302, the compiler engine 300 includes syntax tree generator 406 and instantiator 408. Syntax tree generator 406 parses the source code of the agent definition 402 and generates an abstract syntax tree (AST) representation of the source code. In various embodiments, the AST representation includes a tree structure of nodes, where constants and variables are child nodes to parent nodes including operators or statements. The AST encapsulates the syntactical structure of the source code, i.e., the statements, the mathematical expressions, the variable, and the relationship between those contained within the source code.

Instantiator 408 processes the AST to generate compiled code 302. In operation, instantiator 408 performs semantic analysis on the AST, generates intermediate representations of the code, performs optimizations, and generates machine code that comprises compiled code 302. For the semantic analysis, instantiator 408 checks the source code for semantic correctness. In various embodiments, a semantic check determines whether variables and types included in the AST are properly declared and that the types of operators and objects match. In order to perform the semantic analysis, instantiator 408 instantiates all of the instances of a given object or function type that are included in the source code. Further, instantiator 408 generates a symbol table representing all the named objects—classes, variables, and functions—is created and used to perform the semantic check on the source code.

Instantiator 408 performs a mapping operation for each variable in the symbol table to determine whether the value of the variable is assigned to a source identified in the source code. Instantiator 408 flags the variables that do not have an assigned source as potential learned variables, i.e., the variables that are to be learned during the training process. In various embodiments, these variables do not have a special type indicating that the variables are learned variables. Further, the source code does not expressly indicate that the variables are learned variables. Instantiator 408 automatically identifies those variables as potential variables that are to be learned by virtue of those variables not being assigned to a source. Thus, instantiator 408 operates differently from traditional compilers and interpreters, which would not allow for a variable to be unassigned, undeclared, or otherwise undefined and raise an error during the compilation process.

Instantiator 408 transmits compiled code 302 and a list of potential learned variables to synthesis engine 310. As discussed above, synthesis engine 310 generates initial network 312 based on compiled code 302 and on or more parameters that influence how that compiled code 302 executes. In particular, network builder 412 analyzes the structure of the compiled code 302 to determine the different layers of the neural network architecture and how the outputs of a given layer are linked into inputs of one or more subsequent layers. In various embodiments, network builder 412 also receives, via user input for example, values for certain variables included in the compiled code.

Learned variable identifier 414 included in network builder 412 identifies learned variables 410 within initial network 312. In operation, learned variable identifier 414 analyzes the list of potential learned variables received from instantiator 408 in view of the structure of the layers of the neural network architecture determined by network builder 412 and any values for variables received by network builder 412. For each of the potential learned variables, learned variable identifier 414 determines whether the source of the potential learned variable in a given layer of the neural network architecture is an output from a prior layer of the neural network architecture. If such a source exists, then the potential learned variable is not a variable that is to be learned during training of the neural network. Similarly, learned variable identifier 414 determines whether a value for a potential learned variable has been expressly provided to network builder 412. If such a value has been provided, then the potential learned variable is not a variable that is to be learned during training of the neural network. In such a manner, learned variable identifier 414 processes each of the potential learned variables to determine whether the potential learned variable is truly a variable that is to be learned during training. Once all of the potential learned variables have been processed, learned variable identifier 414 identifies any of the potential learned variables for which a source was not determined. These variables make up learned variables 410 of initial network 312.

In various embodiments, learned variable identifier 414 causes the network generation GUI 202 to display learned variables 410 identified by learned variable identifier 414. Learned variables 410 can then be confirmed by or otherwise modified by a user of the GUI 202, such as the developer of the neural network architecture.

As discussed above, training engine 320 trains initial network 312 based on training data 250 to generate trained network 322. Trained network 322 includes values for the learned variables 410 that are learned during the training process. Trained network 322 may perform the one or more intended operations with a higher degree of accuracy than initial network 312. Training engine 320 may perform any technically feasible type of training operation, including backpropagation, gradient descent, and so forth.

The above techniques provide the user with a convenient mechanism for creating and updating neural networks that are integrated into potentially complex machine learning models 122 that include numerous agents 240. Further, these techniques allow the user to modify program code that defines a given agent 240 via straightforward interactions with a graphical depiction of the corresponding network architecture. Network generator 200 performs the various operations described above based on user interactions conducted via network generation GUI 202. The disclosed techniques provide the user with convenient tools for designing and interacting with neural networks that expose network information to the user rather than allowing that information to remain hidden, as generally found with prior art techniques.

As a general matter, the techniques described above for generating and modifying neural networks allow users to design and modify neural networks much faster than conventional approaches permit. Among other things, network generator 200 provides simple and intuitive tools for performing complex tasks associated with network generation. Additionally, network generator 200 conveniently allows modifications made to a network architecture to be seamlessly propagated back to a corresponding agent definition. Once the network is trained in the manner described, network analyzer 210 performs various techniques for analyzing network functionality.

### Implementing and Managing Container-Based Services

In some embodiments, AI design application 120, database 118, GUI 124, network generator 200, network analyzer 210, network evaluator 220, network descriptor 230, compiler engine 300, synthesis engine 310, training engine 320, visualization engine 330, and/or other components of system 100 of FIG. 1, AI design application 120 of FIG. 2, and/or network generator 200 of FIG. 3 are implemented as services within a machine learning workflow. For example, each of these components could be deployed within a cloud computing environment, a local environment that is geographically in proximity to an entity using the components (e.g., on computers that are “on premises” with respect to a person or organization using the components), and/or another type of environment or platform. Each component could provide a different subset of functionality associated with the machine learning workflow.

To improve the integration, update, and replacement of these services, the disclosed techniques package each service with a corresponding shim into an executable image. The image is used to deploy a container that includes the service and shim within an environment. Within the deployed container, the shim implements a standardized interface (e.g., an application programming interface (API)) for accessing the functionality of the service. The shim also converts between the standardized interface and an implementation-specific interface provided by the service. Consequently, the image, container, and shim provide an abstraction of the functionality provided by the service and allow the service to be updated or replaced without requiring other components to be adapted to the implementation-specific interface provided by the service, as described in further detail below.

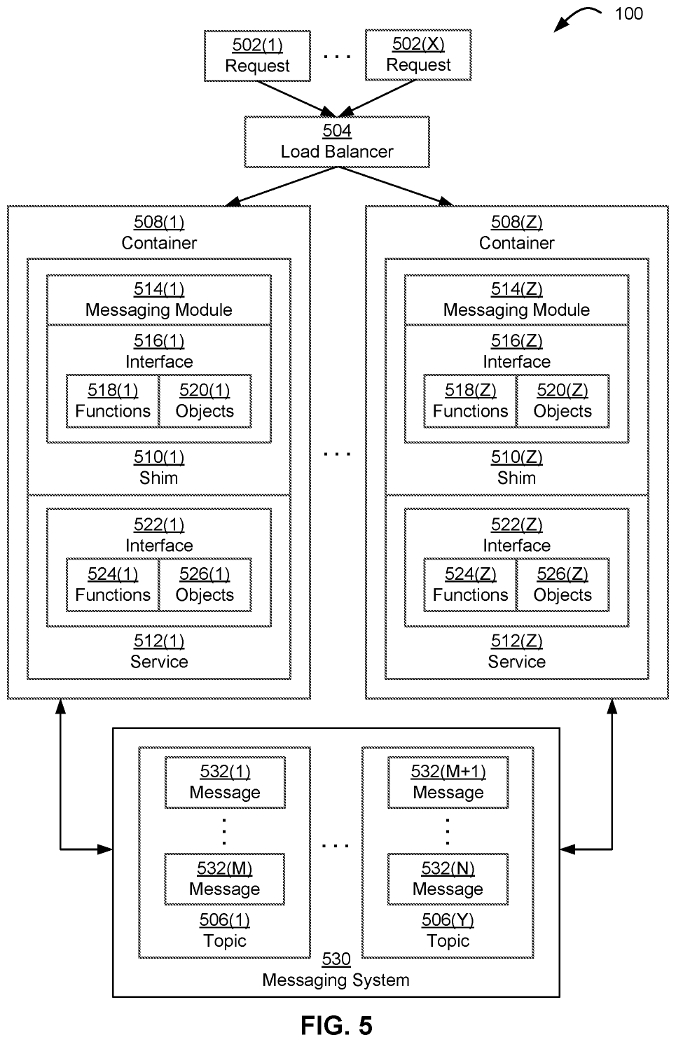

FIG. 5 illustrates an implementation of system 100 of FIG. 1 that includes container-based abstractions of services, according to various embodiments. As shown in FIG. 5, system 100 includes a number of containers 508(1)-(Z) (each of which is referred to individually as container 508), a load balancer 504, and a messaging system 530. Containers 508, load balancer 504, and messaging system 530 are stored or loaded in memory 136 on one or more instances of server 130. Containers 508, load balancer 504, and messaging system 530 can also be read from memory 136 and executed by one or more processors 132 within these instance(s) of server 130. Each of these components is described in further detail below.

Containers 508(1)-(Z) are used to deploy and execute services 512(1)-(Z) (each of which is referred to individually as service 512) within system 100. Each container 508 corresponds to an autonomous, isolated runtime environment for components residing within that container 508. For example, each container 508 could be deployed in a separate physical or virtualized server 130 within a remote cloud computing environment, an on-premises environment, and/or another type of environment. Once a given container 508 is deployed, a separate instance of service 512 could be executed within that container. The network, storage, or other resources used by each container 508 could additionally be isolated from other containers and/or the computer system on which that container 508 runs. Further, containers 508 could be independently created, executed, stopped, moved, copied, snapshotted, and/or deleted.

As mentioned above, service 512 can include one or more components of a machine learning workflow. Service 512 can also, or instead, include one or more components of another type of software workflow and/or technology stack. For example, service 512 could include (but is not limited to) a messaging service, email service, database, data warehouse, document management system, graphics editor, graphics renderer, enterprise application, mobile application, analytics service, web server, content management system, customer relationship management system, and/or identity management system.

In one or more embodiments, the functionality provided by services 512(1)-(Z) is accessed via interfaces 522(1)-(Z) (each of which is referred to individually as interface 522) implemented by services 512(1)-(Z). Interfaces 522(1)-(Z) expose functions 524(1)-(Z) (referred to individually as functions 524) and objects 526(1)-(Z) (referred to individually as objects 526) implemented by services 512(1)-(Z) to other components or services. For example, interface 522 could include an application programming interface (API) for a model training service 512 in a machine learning workflow. The API could be called by other components or services to access functions 524 that are used to assign CPU, GPU, or other resources to a training task; select a training dataset or model architecture for a machine learning model to be trained using the training task; specify hyperparameters associated with the machine learning model; execute the training task; and/or export or save the trained machine learning model at the end of the training task. The API could also, or instead, be called by the other components or services to create or access objects 526 representing compute resources, training datasets, hyperparameters, machine learning models, and/or other entities used in the training task.

Containers 508(1)-(Z) are also used to deploy and execute shims 510(1)-(Z) (each of which is referred to individually as shim 510) associated with service 512. Each shim 510 includes one or more software components that provide a standardized representation of the functionality provided by service 512. In particular, shims 510(1)-(Z) implement interfaces 516(1)-(Z) (each of which is referred to individually as interface 516) that correspond to abstractions of interfaces 522(1)-(Z) implemented by services 512(1)-(Z). These interfaces 516(1)-(Z) include functions 518(1)-(Z) (referred to individually as functions 518) and objects 520(1)-(Z) (referred to individually as objects 520) that are service-agnostic versions of functions 524 and objects 526, respectively, in interfaces 522(1)-(Z) implemented by services 512(1)-(Z).

Continuing with the above example, interface 516 could include a representational state transfer (REST) API that can be called by other components or services executing on one or more clients 110, one or more servers 130, and/or other types of computing devices. The REST API could include “generic” versions of functions 524 and objects 526 used to perform a training task in a machine learning workflow. These generic functions 524 and objects 526 could be used by the other components or services to access the functionality provided by the model training service 512 in lieu of the service-specific functions 524 and objects 526 in interface 516 implemented by service 512.

Shim 510 additionally converts between requests and responses associated with interface 522 and requests and responses associated with interface 516. When shim 510 receives a request over interface 516, shim 510 “translates” the request into one or more requests to interface 522 (e.g., by converting the parameters of the request into parameters of the request(s) to interface 522). Shim 510 also transmits the translated request(s) to interface 522 to cause service 512 to process the translated request(s). When service 512 generates one or more responses to the translated request(s), shim 510 receives the response(s) over interface 52 and “translates” the response(s) into one or more corresponding responses that adhere to interface 516. Shim 510 then transmits the translated response(s) over interface 516 to the service or component from which the original request was received.

An example portion of shim 510 that implements interface 516 and converts between interfaces 516 and 522 includes the following representation:

```
import json
import traceback
from fastapi import Request, APIRouter, Depends
from fastapi.responses import JSONResponse
from sqlalchemy import text
from vianai_rest.vianai_response import VianaiErrorResponse
from dbconnection import getDataStoreEngine,
      getDataStoreConnectionStr
import featureset.service as service
from featureset.model import FeatureSetModelPage
from log_helper import get_vlogger_instance
logger = get_vlogger_instance( )
# Setup router for fastapi
router = APIRouter( )
engine = getDataStoreEngine( )
conn = getDataStoreConnectionStr( )
@router.get (
  ‘/vl/featureset/{setname}’,
  tags=[“featureset”],
  response_model=FeatureSetModelPage,
  responses={
      500: {“model”: VianaiErrorResponse}
  }
)
async def get_paginated_featuresets(request: Request, setname:
    str, page: int, pageSize: int, search: str = None, orderBy
    str=None, orderDirection=‘ASC’):
    try:
      logger.info (f“[featureset.get_paginated_featuresets]
        get_paginated_organizations”)
      featureset_page = await service.find_featureset_pages(
        setname, page, pageSize, search, orderBy,
        orderDirection)
      return JSONResponse(content=json.loads(
        featureset_page.j son( ) ) )
    except Exception as ex:
      logger.error(traceback.format_exc( ) )
      return JSONResponse(status_code=500,content=json.loads(
        VianaiErrorResponse(error=str(ex) ).json( ) ) )
```

In the above representation, interface 516 includes a function named “get_paginated_featuresets.” The “get_paginated_featuresets” function can be invoked using a number of parameters (e.g., “request,” “setname,” “page,” “pageSize,” “search,” “orderBy,” “orderDirection,” etc.). The “get_paginated_featuresets” function uses some of the parameters to generate a call to a “find_featureset_pages” function that is included in interface 522 implemented by the corresponding service 512 (e.g., a feature repository service), thereby translating the invocation of the “get_paginated_featuresets” function by another component into an invocation of the “find_featureset_pages” function provided by service 512. The “get_paginated_featuresets” function additionally converts the response returned by the “find_featureset_pages” function into a corresponding “JSONResponse” that is transmitted to the caller of the “get_paginated_featuresets” function.

Consequently, shim 510 exposes the functionality of service 512 to other components or services without requiring the other components or services to be hardcoded or customized to use interface 522 provided by service 512. Instead, shim 510 provides another interface 516 that abstracts away the implementation details of service 512 or interface 522. When service 512 is replaced with another service (not shown) that provides similar functionality, the other service can also be deployed with a corresponding shim that implements interface 516 and “translates” between requests and responses associated with interface 516 and requests and responses associated with an implementation-specific interface implemented by the other service. Consequently, other components or services that use the functionality provided by service 512 and/or the other service do not need to be modified to accommodate the replacement of service 512 with the other service.

In one or more embodiments, shim 510 and service 512 are packaged together into an image that is deployed and executed within container 508. For example, the image could be built as a series of layers, where each layer applies a different set of changes to the image. This series of layers could be used to add service 512 and shim 510 to the image. After the image is built, a writable container layer could be added to allow modifications to the running image within container 508. Further, container 508 would isolate the running image from the underlying environment and/or other services, shims, or containers running within the same environment.

This packaging, deployment, and execution of shim 510 and service 512 within the same container 508 allows different services that provide similar functionality and corresponding shims to be added to or removed from the environment in a seamless, self-contained manner. For example, a first service and a first shim executing in a first container could be replaced with a second service and a second shim executing in a second container (e.g., when the second service constitutes an improvement, update, or upgrade over the first service). Other services that accessed the functionality provided by the first service via the interface implemented by the first shim would be able to use the same interface, as implemented by the second shim, to access the functionality provided by the second service.

An example script for building an image that includes shim 510 and service 512 includes the following representation:
ARG REPO_PREFIX
FROM ${REPO_PREFIX}_python
COPY startup.sh /startup.sh
COPY app/ /collab/app
RUN chmod +x /startup.sh
RUN pip install watchdog msal
# -- COPY Application files for use in prod deployments, dev will override with volume
ENV PYTHONPATH /source:$PYTHONPATH
# -- Runtime
WORKDIR /collab/app
ENTRYPOINT [“/startup.sh”]
   The first two lines of the script are used to create a base image represented by “${REPO_PREFIX}_python.” Subsequent lines of the script are used to create new layers that are applied to the image. These layers are used to add shim 510, service, and/or other components to the image.

Load balancer 504 receives requests 502(1)-(X) (each of which is referred to individually as request 502) to interface 516 from other components or services. Load balancer 504 routes these requests 502 to different containers 508 on which shim 510 and service 512 execute. For example, load balancer 504 could receive requests 502 to a REST API corresponding to interface 516. Load balancer 504 could also use a load-balancing technique (e.g., round robin, weighted round robin, least loaded, sticky sessions, etc.) to route requests 502 to different containers 508 for subsequent processing of requests 502 by shim 510 and service 512 executing within those containers 508.

In some embodiments, instances of shim 510 communicate with one another using messaging system 530. More specifically, messaging system 530 includes a publish-subscribe messaging system that stores messages in various topics 506(1)-(Y) (each of which is referred to individually as topic 506), which can also be referred to herein as queues. Topic 506(1) is associated with a set of messages 532(1)-(M), and topic 506(Y) is associated with a different set of messages 532(M+1)-(N). Each of messages 532(1)-(M) and messages 532(M+1)-(N) is referred to individually as message 532. Shims 510(1)-(Z) include messaging modules 514(1)-(Z) (each of which is referred to individually as messaging module 514) that subscribe to and read messages from certain topics 506 within messaging system 530. Messaging modules 514 can also be used to write messages to the same topics 506 or different topics 506 in messaging system 530.

More specifically, messaging system 530 allows multiple containers 508 that are deployed within the environment to horizontally scale the functionality provided by service 512 to coordinate with one another during processing of requests 502. After a given shim 510 in receives a certain request 502 to interface 516 (e.g., from load balancer 504), that shim 510 attempts to process the request using the corresponding service 512 within the same container 508. If that shim 510 determines that the corresponding service 512 cannot process the request (e.g., if the corresponding service 512 lacks data and/or objects 526 required to process the request), that shim 510 uses messaging module 514 to publish a message to one or more topics 506 within messaging system 530. The message can include the parameters of the request, an indication that the request cannot be processed by that shim 510 and/or corresponding service 512, and/or one or more reasons for the inability to process the request by that shim 510 and/or corresponding service 512. Messaging modules 514 in other shims 510 can be configured to subscribe to these topics 506, read the message from these topics 506, and attempt to process the request within the message. One or more of these other shims 510 can additionally determine that the corresponding services 512 include the data and/or objects required to process the request (e.g., by converting the request into one or more corresponding requests to interface 522 and transmitting the corresponding request(s) over interface 522 to the corresponding services 512). These shims 510 can also use the corresponding services 512 to generate a response to the request and transmit the response over interface 516 to the component from which the request originated. Consequently, shims 510 can use messaging modules 514 and messaging system 530 to “fan out” requests 502 to one another, thereby providing asynchronous communication, alerting, and reporting across containers 508 even when the underlying services 512 are not implemented to support horizontal scaling or asynchronous interactions.

An example portion of messaging module 514 that publishes messages to topics 506 within messaging system 530 includes the following representation:

```
def send_event_bus_status_sync(payload):
  try:
    messenger.sendEventSync(payload)
  except Exception as e:
    logger.error(
      f“{CHANNEL_PUBLISHER}: Encountered an error sending
        event to event bus: {e}”,
      exc_info=True,
    )
def update_status (
  job_id: str, status: str, finished=str, result=“ ”,
    exception=“ ”, statusdetails=“ ”
):
  r = Redis.from_url(url=REDIS_URL)
  logger.info(
    f“job list len ({r.llen (RETRAINING_JOBLIST_NAME) } )”
  )
  found = False
  if r.llen(RETRAINING_JOBLIST_NAME) > 0:
    for i in range(0, r.llen(RETRAINING_JOBLIST_NAME) ):
      job = json.loads(r.lindex(RETRAINING_JOBLIST_NAME,
        i) )
      if job is not None and “job_id” in job:
        if job_id in job[“job_id”]:
          r.lrem(
            RETRAINING_JOBLIST_NAME,
            value=r.lindex(RETRAINING_JOBLIST_NAME,
              i) ,
            count=1,
          )
          job[“status”] = status
          job[“finished”] = finished
          job[“timestamp”] =
            datetime.now( ).timestamp( ) * 1000
          job[“result”] = result
          job[“exception”] = exception
          job[“statusdetails”] = statusdetails
          logger.warning(
            f“ updated {job}”
          )
          r.lpush (RETRAINING_JOBLIST_NAME,
            json.dumps(job) )
          logger.info (
            f “{CHANNEL_PUBLISHER} is
                publishing: \n {job}”
          )
          send_event_bus_status_sync(json.dumps(job) )
          found = True
  if found is False:
  job = {
      “job_id”: job_id,
      “status”: status,
      “statusdetails”: statusdetails,
      “result”: result,
      “exception”: exception,
      “created”: str(datetime.now( ) ),
      “started”: str(datetime.now( ) ),
      “finished”: finished,
      “timestamp”: datetime.now( ).timestamp( ) * 1000,
      “configmap”: “ ”,
    }
    r.lpush(RETRAINING_JOBLIST_NAME, json.dumps (job) )
```

In the above representation, the “update_status” function generates a JavaScript Object Notation (JSON) object that stores fields related to the status of a job (e.g., “job_id,” “status,” “finished,” “statusdetails,” “result,” “exception,” etc.) that is processed using shim 510 and/or the corresponding service 512. The update_status” function also calls a “send_event_bus_status_sync” function to publish the JSON object as a message to one or more topics 506 within messaging system 530. Other shims 510 that subscribe to these topics 506 can retrieve the message from these topics 506 and determine, based on the status fields in the message, whether or not the job was completed successfully on shim 510. If the other shims 510 determine that the job was not completed successfully on shim 510, the other shims 510 can attempt to perform the job using other status fields in the message.

While the functionality of system 100 has been described above with respect to upgrading, updating, or replacing services, it will be appreciated that system 100 can be configured to manage multiple services with similar functionality in other ways. For example, system 100 could include multiple model training services 512 and corresponding shims 510 that are deployed within multiple sets of containers 508. Each model training service 512 could include features or performance characteristics that are optimized for certain types of machine learning models (e.g., neural networks, regression models, tree-based models, support vector machines, etc.), model sizes, training datasets (e.g., unstructured data, structured data, text-based data, images, video, etc.), hyperparameters, training techniques, and/or other factors related to training machine learning models. Load balancer 504 could be configured to route messages that include requests 502 to train machine learning models to the corresponding containers 508 and/or shims 510 based on fields in requests 502 associated with these factors, so that a training task represented by each request is executed by a model training service 512 that is most suited for that training task. Load balancer 504 could also, or instead, be configured to route these types of messages to certain containers 508 and/or shims 510 based on fields in requests 502 that include identifiers for containers 508, shims 510, and/or the underlying services 512 that are selected by users that generated these requests 502.

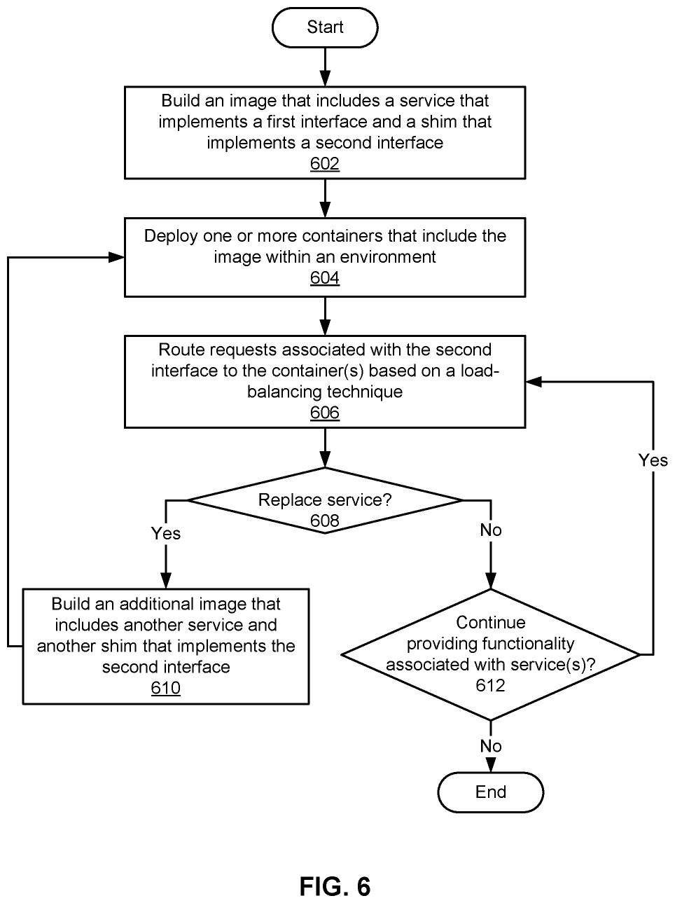

FIG. 6 sets forth a flow diagram of method steps of implementing one or more services in a technology stack, according to various embodiments. Although the method steps are described in conjunction with the systems of FIGS. 1-5, persons skilled in the art will understand that any system configured to perform the method steps in any order falls within the scope of the present disclosure.

As shown, system 100 builds 602 an image that includes a service that implements a first interface and a shim that implements a second interface. For example, system 100 could start with a base image and use a series of layers to apply a series of changes to the image. One or more layers could be used to add one or more components of the service to the image, and one or more other layers could be used to add one or more components of the shim to the image.

Next, system 100 deploys 604 one or more containers that include the image within an environment. For example, system 100 could create each container as an isolated environment within a larger cloud-based or on-premises environment. After a given container is created, system 100 could run the image within the container.

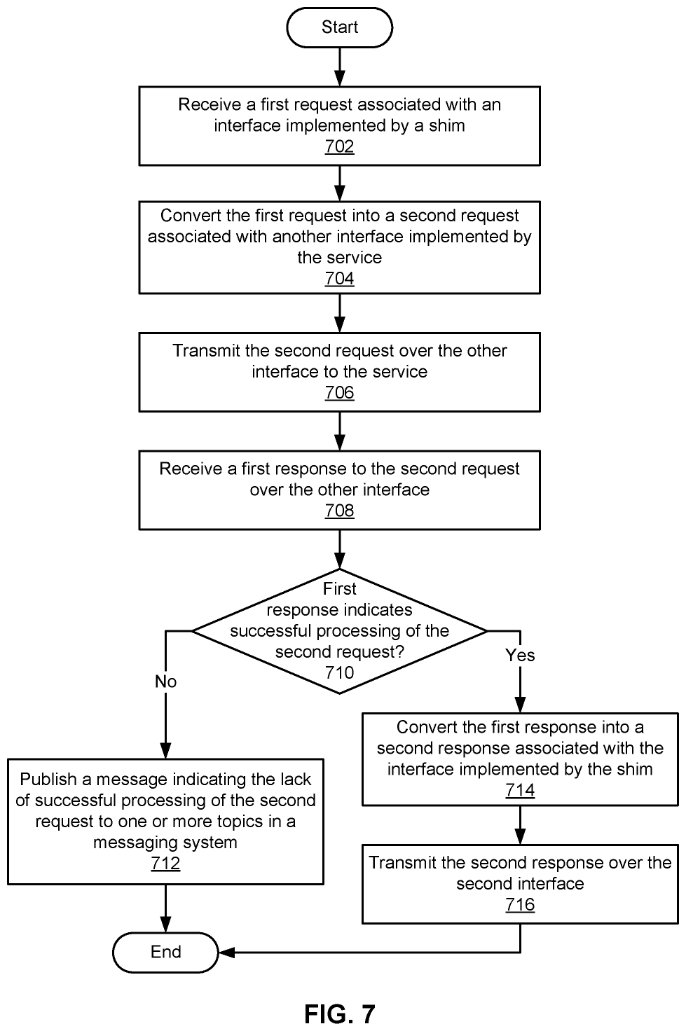

System 100 also routes 606 requests associated with the second interface to the container(s) based on a load-balancing technique. For example, system 100 could include a load balancer that receives the requests over a REST API. The load balancer could also use a round robin, weighted round robin, sticky sessions, and/or another type of load balancing technique to distribute the requests across the container(s). The requests could then be processed by instances of the shim and service in the corresponding containers, as described in further detail below with respect to FIG. 7.

While the load balancer is used to route requests to the container(s), system 100 and/or another entity determine 608 whether or not the service is to be replaced. For example, an administrator could determine that the service is to be replaced when a newer version of the service is available, an upgrade to the service is available, a configuration associated with system 100 is updated, a different service that provides the same functionality is available, and/or another condition is met. The administrator could also transmit one or more commands to system 100, update a configuration associated with system 100, and/or otherwise indicate to system 100 that the service is to be replaced.

Once system 100 and/or another entity determines that the service is to be replaced, system 100 builds 610 an additional image that includes another service and another shim that implements the second interface. For example, system 100 could package the other service and the other shim into the additional image. The other service could provide functionality that is similar to the service that is currently used to process requests, and the other shim could translate between requests and responses associated with the interface implemented by the other service and the second interface. System 100 additionally deploys 604 one or more containers that include the newly built image within the environment. System 100 further repeats operations 606-612 to route requests to the other shim and service executing within the corresponding container(s) and/or replace the other service.

When a service is not being replaced, system 100 determines 612 whether or not functionality associated with the service (or similar services) should continue to be provided. While functionality associated with the service(s) continues to be provided, system 100 using the load balancer to route 606 requests associated with the second interface to the currently deployed container(s) and/or performs operations 608-610 and 604 to replace the service as the need arises. Once system 100 determines that functionality associated with the service(s) is no longer to be provided, system 100 can stop the container(s) in which the service(s) are deployed and/or discontinue routing requests associated with the second interface to the container(s).

FIG. 7 sets forth a flow diagram of method steps for processing a request associated with a service implemented in a technology stack, according to various embodiments. Although the method steps are described in conjunction with the systems of FIGS. 1-5, persons skilled in the art will understand that any system configured to perform the method steps in any order falls within the scope of the present disclosure.

As shown, shim 510 receives 702 a first request associated with an interface implemented by the shim. For example, shim 510 could receive the first request from a load balancer and/or over a REST API corresponding to the interface.

Next, shim 510 converts 704 the first request into a second request associated with another interface implemented by a service. For example, shim 510 could obtain a set of parameters from a call to a function within the first request. Shim 510 could use the parameters to generate a call to a different function within the other interface implemented by the service. Shim 510 also transmits 706 the second request over the other interface to the service.

Shim 510 subsequently receives 708 a first response to the second request over the other interface. For example, shim 510 could receive the first response after the service has processed the second request.

Shim 510 determines 710 whether the first response indicates successful processing of the second request. For example, shim 510 could determine that the second request was processed successfully when the first response includes a status field that indicates completion of a job associated with processing the second request. On the other hand, shim 510 could determine that the second request was not processed successfully when the first response includes one or more errors and/or other indicators of a lack of completion of the job.

When the first response indicates that the second request has not been processed successfully, shim 510 publishes 712 a message to one or more topics in a messaging system indicating that the second request was unsuccessfully processed. For example, shim 510 could generate a message that includes the first request, second request, and/or status fields associated with the first response. Shim 510 could also and write the message to the topic(s) within a publish-subscribe messaging system. Other instances of shim 510 executing within other containers could read the message from the topic(s) and attempt to process one or both requests. This fan-out of the request(s) to the other instances of shim 510 allows an instance of shim 510 that is coupled to an instance of the service that includes data and/or objects needed to process the request(s) to successfully process the request(s) and transmit a response to the component from which the first request was received.

When the first response indicates that the second request has been processed successfully, shim 510 converts 714 the first response into a second response associated with the interface implemented by the shim. For example, shim 510 could convert the objects and/or format associated with the first response into objects and/or format associated with the second response. Shim 510 then transmits 716 the second response over the second interface.

In sum, the disclosed techniques provide container-based service abstractions within a cloud-based environment, an on-premises environment, and/or another type of environment that hosts running services. Each service is packaged with a corresponding shim into an executable image, and a container that runs the image is deployed within the environment. The shim implements a standardized interface for accessing the functionality of the service and converts between the standardized interface and an interface that is specific to the service. When the service is to be replaced with another service that provides similar functionality, another container that includes the other service and a different shim that converts between the standardized interface and another interface that is specific to the other service is deployed within the environment. Requests to the standardized interface are then routed to the other container.

One technical advantage of the disclosed techniques relative to the prior art is that, with the disclosed techniques, the same interface can be used to access multiple services that provide similar functionality within a given technology stack. Accordingly, the disclosed techniques enable a service to be added, updated, upgraded, or replaced within the technology stack without having to create and install a custom “driver” to accommodate the modified or added service or change the interfaces of the other implemented in the technology stack, as is normally required with prior art approaches. Another technical advantage of the disclosed techniques is that, because a service and a corresponding shim are packaged together within the same container, the service and shim are isolated from other components executing within the same environment. This isolation allows the service and shim to be deployed, moved, and removed as a single self-contained unit, which is more efficient relative to prior art approaches where services and components are packaged, deployed, and managed separately. These technical advantages provide one or more technological improvements over prior art approaches.

1. In some embodiments, a computer-implemented method for executing one or more services in a technology stack comprises deploying a first set of containers within an environment, wherein each container included in the first set of containers includes a first service that implements a first interface and a first shim that implements a second interface; and transmitting a first request associated with the second interface to a first container included in the first set of containers, wherein the first request is processed by an instance of the first shim and an instance of the first service executing within the first container.

2. The computer-implemented method of clause 1, wherein deploying the first set of containers comprises building a first image as a series of layers, wherein the first image is associated with the first set of containers, and the series of layers includes the first service and the first shim; and executing the first image within each container included in the first set of containers.

3. The computer-implemented method of any of clauses 1-2, further comprising deploying a second set of containers within the environment, wherein each container included in the second set of containers includes a second service that implements a third interface and a second shim that implements the second interface; and transmitting a second request associated with the second interface to a second container included in the second set of containers, wherein the second request is processed by an instance of the second shim and an instance of the second service executing within the second container.

4. The computer-implemented method of any of clauses 1-3, further comprising, in response to deploying the second set of containers within the environment, removing the first set of containers from the environment.

5. The computer-implemented method of any of clauses 1-4, further comprising receiving, via a messaging system, a first message associated with the first request from the first container; and transmitting, via the messaging system, the first message to one or more additional containers included in the first set of containers, wherein the first message is used by one or more additional instances of the first shim and one or more additional instances of the first service executing within the one or more additional containers to further process the first request.

6. The computer-implemented method of any of clauses 1-5, wherein the first message comprises one or more parameters included in the first request and a first status associated with processing the first request.

7. The computer-implemented method of any of clauses 1-6, wherein the messaging system comprises a publish-subscribe messaging system.

8. The computer-implemented method of any of clauses 1-7, wherein transmitting the first request to the first container comprises determining that the first request should be routed to the first container based on a load-balancing technique.

9. The computer-implemented method of any of clauses 1-8, wherein the instance of the first shim processes the first request associated with the second interface by converting the first request into a second request associated with the first interface.

10. The computer-implemented method of any of clauses 1-9, wherein the first service comprises at least one of a model repository, a feature store, a model training service, or a model execution service.

11. In some embodiments, one or more non-transitory computer-readable media store instructions that, when executed by one or more processors, cause the one or more processors to perform the steps of deploying a first set of containers within an environment, wherein each container included in the first set of containers includes a first service that implements a first interface and a first shim that implements a second interface; and transmitting a first request associated with the second interface to a first container included in the first set of containers, wherein the first request is processed by an instance of the first shim and an instance of the first service executing within the first container.

12. The one or more non-transitory computer-readable media of clause 11, wherein deploying the first set of containers comprises applying a series of changes to a first image to add the first service and the first shim to the first image, wherein the first image is associated with the first set of containers; and executing the first image within each container included in the first set of containers.

13. The one or more non-transitory computer-readable media of any of clauses 11-12, wherein the instructions further cause the one or more processors to perform the steps of deploying a second set of containers within the environment, wherein each container included in the second set of containers includes a second service that implements a third interface and a second shim that implements the second interface; and transmitting a second request associated with the second interface to a second container included in the second set of containers, wherein the second request is processed by an instance of the second shim and an instance of the second service executing within a second container included in the second set of containers.

14. The one or more non-transitory computer-readable media of any of clauses 11-13, wherein transmitting the second request to the second container comprises determining that the second request should be routed to the second container based on one or more fields included in the request.

15. The one or more non-transitory computer-readable media of any of clauses 11-14, wherein the instructions further cause the one or more processors to perform the steps of receiving, via a messaging system, a first message associated with the first request from the first container; and transmitting, via one or more topics included in the messaging system, the first message to one or more additional containers included in the first set of containers, wherein the first message is used by one or more additional instances of the first shim and one or more additional instances of the first service executing within the one or more additional containers to process the first request.

16. The one or more non-transitory computer-readable media of any of clauses 11-15, wherein the first message comprises one or more parameters included in the first request and a first status associated with processing the first request.

17. The one or more non-transitory computer-readable media of any of clauses 11-16, wherein transmitting the first request to the first container comprises determining that the first request should be routed to the first container based on a load-balancing technique.

18. The one or more non-transitory computer-readable media of any of clauses 11-17, wherein the second interface comprises a representational state transfer application programming interface.

19. The one or more non-transitory computer-readable media of any of clauses 11-18, wherein the first interface comprises a first set of objects and a first set of functions and the second interface comprises a second set of objects and a second set of functions.

20. In some embodiments, a system comprises one or more memories that store instructions, and one or more processors that are coupled to the one or more memories and, when executing the instructions, are configured to perform the steps of deploying a first set of containers within an environment, wherein each container included in the first set of containers includes a first service that implements a first interface and a first shim that implements a second interface; and transmitting a first request associated with the second interface to a first container included in the first set of containers, wherein the first request is processed by an instance of the first shim and an instance of the first service executing within the first container.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for executing one or more services in a technology stack, the method comprising:
deploying a first set of containers within an environment, wherein each container included in the first set of containers includes a first service that implements a first interface and a first shim that implements a second interface; and
transmitting a first request associated with the second interface to a first container included in the first set of containers, wherein the first request is processed by an instance of the first shim and an instance of the first service executing within the first container.

2. The computer-implemented method of claim 1, wherein deploying the first set of containers comprises:
building a first image as a series of layers, wherein the first image is associated with the first set of containers, and the series of layers includes the first service and the first shim; and
executing the first image within each container included in the first set of containers.

3. The computer-implemented method of claim 1, further comprising:
deploying a second set of containers within the environment, wherein each container included in the second set of containers includes a second service that implements a third interface and a second shim that implements the second interface; and
transmitting a second request associated with the second interface to a second container included in the second set of containers, wherein the second request is processed by an instance of the second shim and an instance of the second service executing within the second container.

4. The computer-implemented method of claim 3, further comprising, in response to deploying the second set of containers within the environment, removing the first set of containers from the environment.

5. The computer-implemented method of claim 1, further comprising:
receiving, via a messaging system, a first message associated with the first request from the first container; and
transmitting, via the messaging system, the first message to one or more additional containers included in the first set of containers, wherein the first message is used by one or more additional instances of the first shim and one or more additional instances of the first service executing within the one or more additional containers to further process the first request.

6. The computer-implemented method of claim 5, wherein the first message comprises one or more parameters included in the first request and a first status associated with processing the first request.

7. The computer-implemented method of claim 5, wherein the messaging system comprises a publish-subscribe messaging system.

8. The computer-implemented method of claim 1, wherein transmitting the first request to the first container comprises determining that the first request should be routed to the first container based on a load-balancing technique.

9. The computer-implemented method of claim 1, wherein the instance of the first shim processes the first request associated with the second interface by converting the first request into a second request associated with the first interface.

10. The computer-implemented method of claim 1, wherein the first service comprises at least one of a model repository, a feature store, a model training service, or a model execution service.

11. One or more non-transitory computer-readable media storing instructions that, when executed by one or more processors, cause the one or more processors to perform the steps of:
deploying a first set of containers within an environment, wherein each container included in the first set of containers includes a first service that implements a first interface and a first shim that implements a second interface; and
transmitting a first request associated with the second interface to a first container included in the first set of containers, wherein the first request is processed by an instance of the first shim and an instance of the first service executing within the first container.

12. The one or more non-transitory computer-readable media of claim 11, wherein deploying the first set of containers comprises:
applying a series of changes to a first image to add the first service and the first shim to the first image, wherein the first image is associated with the first set of containers; and
executing the first image within each container included in the first set of containers.

13. The one or more non-transitory computer-readable media of claim 11, wherein the instructions further cause the one or more processors to perform the steps of:
deploying a second set of containers within the environment, wherein each container included in the second set of containers includes a second service that implements a third interface and a second shim that implements the second interface; and
transmitting a second request associated with the second interface to a second container included in the second set of containers, wherein the second request is processed by an instance of the second shim and an instance of the second service executing within a second container included in the second set of containers.

14. The one or more non-transitory computer-readable media of claim 13, wherein transmitting the second request to the second container comprises determining that the second request should be routed to the second container based on one or more fields included in the request.

15. The one or more non-transitory computer-readable media of claim 11, wherein the instructions further cause the one or more processors to perform the steps of:
receiving, via a messaging system, a first message associated with the first request from the first container; and
transmitting, via one or more topics included in the messaging system, the first message to one or more additional containers included in the first set of containers, wherein the first message is used by one or more additional instances of the first shim and one or more additional instances of the first service executing within the one or more additional containers to process the first request.

16. The one or more non-transitory computer-readable media of claim 15, wherein the first message comprises one or more parameters included in the first request and a first status associated with processing the first request.

17. The one or more non-transitory computer-readable media of claim 11, wherein transmitting the first request to the first container comprises determining that the first request should be routed to the first container based on a load-balancing technique.

18. The one or more non-transitory computer-readable media of claim 11, wherein the second interface comprises a representational state transfer application programming interface.

19. The one or more non-transitory computer-readable media of claim 11, wherein the first interface comprises a first set of objects and a first set of functions and the second interface comprises a second set of objects and a second set of functions.

20. A system, comprising:
one or more memories that store instructions, and
one or more processors that are coupled to the one or more memories and, when executing the instructions, are configured to perform the steps of:
deploying a first set of containers within an environment, wherein each container included in the first set of containers includes a first service that implements a first interface and a first shim that implements a second interface; and
transmitting a first request associated with the second interface to a first container included in the first set of containers, wherein the first request is processed by an instance of the first shim and an instance of the first service executing within the first container.
